(19) United States
(12) Patent Application Publication
(10) Pub. No.: US 2010/0293375 A1
(43) Pub. Date: Nov. 18, 2010

(54) METHOD FOR THE REMOTE ANALYSIS OF A COOKING APPLIANCE, AND A COOKING APPLICATION FOR CONDUCTING SAID METHOD

(75) Inventors: Laszlo Dobos, Erdweg (DE); Michael Greiner, Landsberg (DE); Erwin Schuller, Wolfratshausen (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: RATIONAL AG, Landsberg/Lech (DE)

(21) Appl. No.: 12/520,851

(22) PCT Filed: Dec. 19, 2007
(86) PCT No.: PCT/EP07/11200

§ 371 Date: Dec. 16, 2009

(30) Foreign Application Priority Data
Dec. 22, 2006 (DE) 102006062244.8-31

(51) Int. Cl. H04L 9/32

(52) U.S. Cl. 713/168

(57) ABSTRACT

The invention relates to a method for storing data in a memory of a cooking appliance and/or for reading data from the memory of the cooking appliance, wherein the cooking appliance comprises at least one interface to a server. In a first step, data of the cooking appliance is stored in the memory, and in a second step, following authentication by the server in relation to the cooking appliance, data is read from the memory by the server via encoded data transmission. The invention further relates to a cooking appliance, comprising at least one memory, a user interface, and at least one interface to at least one server in order to carry out such a method for the purpose of transmitting data between the memory and at least the server.

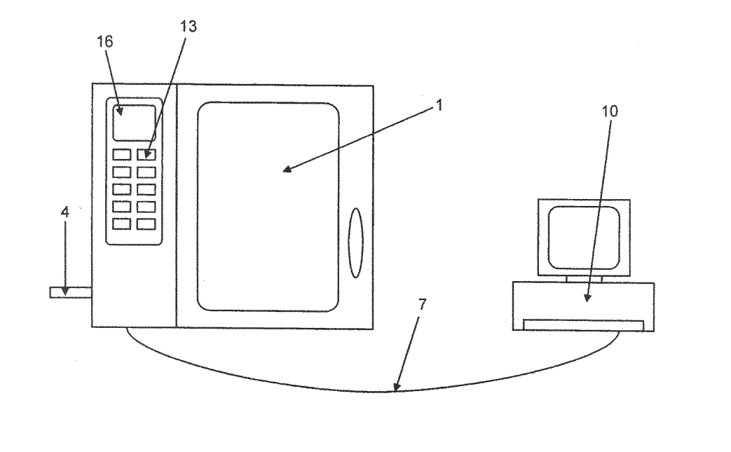

The present invention relates to a method for storing data in a memory of a cooking appliance and/or for reading out data from the memory of the cooking appliance, the cooking appliance having at least one interface to a server. Furthermore, the invention relates to a cooking appliance, comprising at least one memory, a user interface, and at least one interface to a server for transmitting electronic data.

Various methods for data communication between cooking appliances and one or more central computing units are known in the prior art. Thus, DE 10 2005 010 061 A1 discloses a method for configuring commercial cooking appliances and a commercial cooking appliance system. Accordingly, centrally developed control and cooking software is loaded on a transportable storage medium and the appliance software of the cooking appliance is updated via this storage medium. The disadvantage here is that a material transport, namely of the storage medium, must occur between a development central office and the cooking appliances.

DE 100 57 849 A1 discloses a system for operating, controlling, and servicing household appliances, in particular stoves and/or exhaust hoods. The appliances to be controlled are connected via an interface to a data transmission system, whereby the appliances to be controlled have a communication link to one another via monitoring and control units and to external control units. The goal of this system is thus to control and monitor multiple household appliances simultaneously via a remote data transmission. It is disadvantageous here that the household appliances must be registered by a service technician, for example. Accordingly, all appliances must be equipped with an IP address via a domain, which causes significant effort. In addition, the data transmission channels are thus externally assailable.

DE 10 2004 008 335 A1 discloses a household appliance or the like, which can be controlled and/or regulated using an EDP program. With the aid of existing interfaces, e.g., serial and infrared interfaces, a local connection is to be established between the household appliance and a computer. For this purpose, a computer, such as a laptop, is directly connected to the serial interface or is directly connected to the infrared interface. It is disadvantageous here that central control and measured value acquisition of multiple cooking appliances is thus not possible, but rather a computer is required for each cooking appliance and the computer must be transported to the cooking appliance. In order to avoid the problems when addressing the cooking appliances, a data transmission via a larger network or the Internet is not provided additionally.

Furthermore, a method and a device for monitoring one or more electrical household appliances which are connected to a household communication network is disclosed in US 2004/0002779 A1, the household communication network being connected via a gateway to an external communication network, via which an external server may be accessed. In this context, the monitoring of the household appliances within the household network is to be ensured by a monitoring device. Generalized functions are stored in a memory of this monitoring device, using which a unified control of different household appliances may be performed. An electrical household appliance comprises a memory unit, from which data may be transmitted via the household communication network to the monitoring unit. An air conditioner is cited as an exemplary household appliance in US 2004/0002779 A1, for which new software may be downloaded from the external server for the installation of a software upgrade.

A control system for controlling a plurality of household appliances, which have a communication connection via data pathways to a central control unit, is described in DE 195 05 684 A1. Inside the control system, a storage medium for storing content specific to household appliances is associated with the household appliances, the content of the particular storage system being able to be requested, accepted, and used for the control of the household appliances by the central control unit. Furthermore, it is proposed by DE 195 05 684 A1 that identification files, functional routine files, and operator guidance files be stored in the particular storage media. The storage media specific to the household appliances, such as compact disc memories or “smart cards,” may be removably attached to the household appliance.

A generic method and a generic cooking appliance are known, for example, from DE 102 01 217 A1, which discloses a cooking appliance and a method for securing the data of control data of a cooking appliance. For this purpose, a protected memory area of a Web server is associated with the cooking appliance, which is connectable via the Internet to the cooking appliance. An electronic controller of the cooking appliance and/or an electrical measured value detection of the cooking appliance may access this storage area after an authentication. A problem for this purpose is that, through the access capability of the cooking appliance to a memory of the Web server, a registration of the cooking appliance using a separate IP address is typical. For this purpose, not only does a corresponding domain have to be provided by the cooking appliance producer and each appliance registered individually, but rather the cooking appliance is also externally identifiable and the data transmission is thus assailable. In addition, the danger that third parties will achieve access to the Web server and acquire unauthorized data therein exists.

The present invention is therefore based on the object of refining the generic method in such a way that the disadvantages of the prior art are overcome. In particular, a more secure data connection of a central server to a plurality of cooking appliances is to be made possible, which is also still to be implemented as simply and effortlessly as possible.

This object is achieved according to the invention in that, in a first step, data of the cooking appliance are stored on the memory, and, in a second step, after an authentication of the server in relation to the cooking appliance, data are read out from the memory by the server via an encrypted data transmission.

It may be provided that the server identifies itself in relation to the memory using an authentication.

Furthermore, it is proposed by the invention that the establishment of the encrypted data transmission is performed by a corresponding configuration of the cooking appliance, in particular of the memory.

It is preferable that the configuration is determined by at least one manual request, in particular via a user interface of the cooking appliance, at least one predefined asynchronous event, such as an error message, and/or by a triggering command, either at regular time intervals and/or according to timetables.

It may in turn be provided according to the invention that the request, the asynchronous event, and/or the triggering command is/are recorded in the memory.

It is also proposed by the invention that the server has access or has no access to the memory as a function of the request, the asynchronous event, and/or the triggering command.

Furthermore, it may be provided that, depending on the request, the asynchronous event, and/or the triggering command, the server reads out data from the memory, analyzes data, and/or stores data in a databank, and/or the server stores data from the databank in the memory, the databank preferably being provided by the server.

It is preferred according to the invention that the cooking appliance processes data stored by the server in the memory and/or displays data on a display unit of the cooking appliance and/or prints out data.

It is also proposed according to the invention that the data are selected from data which are characteristic for HACCP logs, at least one customer input, the type and/or number of at least one completed or aborted cleaning, decalcification, cooling, and/or cooking program, at least one error message, consumption data, for example, for a power, water, and/or gas consumption, and/or at least one run time of at least one system component of the cooking appliance, such as a heating unit, a cooling unit, a cleaning unit, a fan unit, a circulation unit, a steam generator, a unit for atomizing water, a unit for supplying moisture, a unit for exhausting moisture, a unit for applying a pressure, a unit for closing a cooking chamber, and the like.

Furthermore, it may be provided that, with the data of the cooking appliance, associated time data are also stored, comprising date and/or time of day, and/or data on the setup location of the cooking appliance, comprising geographic location and/or geodetic altitude.

The invention also provides that the data are stored in a format readable by standard editors and/or encrypted.

It may also be provided that the data transmission, which is encrypted in particular, is performed via a network connection, such as an Internet or intranet, in particular if the memory remains connected to the cooking appliance, or directly, if the memory is disconnected from the cooking appliance.

Furthermore, it may be provided according to the invention that the memory may be disconnected from the cooking appliance and connected to a computing unit, such as a local computer or the like.

Finally, it is also preferable according to the invention that the server and/or the databank can be connected to a plurality of cooking appliances, and/or the server and/or each cooking appliance can be connected to a cash register system.

The invention also provides a cooking appliance, comprising at least one memory, a user interface, and at least one interface to at least one server, for performing a method according to the invention for the purpose of transmitting data between the memory and the server.

It may be provided that the interface comprises a USB interface.

Furthermore, it may be provided according to the invention that the memory is removably or permanently situated in the cooking appliance, a removable memory being shaped in particular as a USB stick.

Cooking appliances according to the invention may also be characterized by a router, in particular a GPRS router, for wireless data transmission between the memory and the server.

The invention is thus based on the surprising finding that because a server executes an exchange of data with a cooking appliance and the cooking appliance itself thus does not require access to the memory of the server, an encrypted connection may be established, in which no separate IP address must be provided for the cooking appliance, so that the construction for implementing the method according to the invention is kept simple and uncomplicated, on the one hand, and is externally attackable only with extreme difficulty, on the other hand.

By that the required administration effort, which is thus restricted to the care of the domain of the server, is reduced, because an additional domain to assign an IP address for the cooking appliance is no longer necessary if the server has access to the memory of the cooking appliance through an encrypted connection. Thanks to the targeted encrypted data transmission, the cooking appliance may exchange data with the server via the Internet or an intranet through a so-called communication tunnel without a separate IP address. Therefore, programs which are only stored on the server can read out encrypted data from the memory of the cooking appliance. These programs contain necessary decoding methods. The security of the data transmission is thus simultaneously significantly improved, without restricting the functionality.

Additional security may be provided in that the memory of the cooking appliance is disconnectable therefrom and may communicate with the server via a separate connection to the Internet or the intranet. The establishment of the communication tunnel is performed by a corresponding configuration of the cooking appliance and/or the memory and may be triggered therefrom.

The triggering command which results in the establishment of the connection may also be given by the cooking appliance and/or the memory. This may be performed either by manual input at a user interface of the cooking appliance, or may also be initiated by predefined asynchronous events, such as error messages within the cooking appliance software. Timetables are also conceivable, which trigger the establishment of the connection at specific times. Of course, a combination of multiple criteria for delivering the triggering command by the cooking appliance or the memory also comes into consideration.

To improve the security, the server reacts to the triggering command with authentication, which the cooking appliance or the memory first checks before an encrypted connection is established by the cooking appliance and/or the memory to the server via the Internet or an intranet.

If the communication tunnel between the cooking appliance and the server has been established once, all possible data may be read out via it by the server from the memory of the cooking appliance and data may also be written by the server in the memory of the cooking appliance.

Because the cooking appliance typically has no connection to the server in operation, the desired data must be written by the cooking appliance in the memory beforehand. The data may be characteristic for so-called HACCP logs (hazard analysis and critical control points), power, water, and/or gas consumption of the cooking appliance, frequency of use of various cleaning, decalcification, and/or cooking programs, and/or the run time of various assemblies, such as steam generators, pumps, magnetrons, heater, ignition devices for gas burners, motor of a fan wheel and/or the like. For example, the knowledge of the frequency of use of the cooking programs allows not only market research, but rather also the checking of the accounting in a restaurant operation, preferably in the event of interconnection with a cash register system, which provides great advantages centrally for all branches in particular for large chains. It also permits warehouse management.

The reading of the data from the memory of the cooking appliance may be performed using suitable programs which are stored on the server. Using these programs, encrypted stored data may be read by the cooking appliance and number columns may be associated with specific parameters of the cooking appliance. The server then stores these data in a databank and/or in well readable form, i.e., in a form which can be read by normal editors.

If the data have been stored by the server from the memory of the cooking appliance in the databank of the server, these data may be processed by programs stored on the server, in order to provide a special service to the user, on the one hand, and to provide the producer of the cooking appliance with suitable information for the improvement thereof, on the other hand. For this purpose, the cooking appliance may also transmit a specific request for the analysis of the retrieved data to the server with the triggering command. If the server receives this request, a specific analysis of the data may be performed by the server and this analysis may be written through the communication tunnel in the memory of the cooking appliance. The cooking appliance may then make the data in the memory accessible to the analysis of the user. Alternatively thereto, the memory itself may also be connected to a computer and the analysis may be made available in a user-friendly way to the user on a display screen or as a printout. Thus, for example, an overview of the consumption values of his cooking appliance may be provided to the user.

Together with the data or separately therefrom, marketing tools, such as advertising films or the like, are transmittable via the server to the cooking appliance. For example, an advertising film may be presented via a display unit of the cooking appliance.

On the basis of the data of multiple cooking appliances, which are centrally collected by a server, the producer may react to error messages of the individual cooking appliances or entire groups of cooking appliances and monitor the service life of individual components. Through a regional organization of the data of the cooking appliances in the databank of the server, region-specific preferences and desires may also be recognized and, for example, cooking programs may be optimized in accordance with country settings. Errors occurring with regional delimitation may also be recognized. Some errors may also be reacted to, in that a server writes a software solution for an error occurring in a specific cooking appliance or a specific customer desire in the memory of the cooking appliance in the memory of the cooking appliance, which the cooking appliance then processes correspondingly, i.e., adds the software located in its memory to the device software, and/or replaces faulty or undesired parts of the software.

Further features and advantages of the invention result from the following description, in which an embodiment of a cooking appliance according to the invention is explained for exemplary purposes on the basis of a schematic drawing. The drawing comprises only one FIGURE with such a cooking appliance and a server.

In detail, the FIGURE shows a cooking appliance 1 having a memory 4, which may be connected via a connection for data transmission 7 to a server 10.

During its operation, the cooking appliance 1 records a plurality of operating data and stores them in the memory 4. These data may be divided into data of special interest for the user and data of special interest for the producer of the cooking appliance.

Data of special interest for the user are particularly consumption data of the cooking appliance 1, for example, on the power, water, and gas consumption, on the consumption of cleaning substances or other supplies. However, also so-called HACCP logs, with which the correct execution of a cooking program may be monitored and possibly also reconsidered, are also of interest to the user.

For the producer of the cooking appliance 1, in addition to the consumption values, above all the error messages of the device software and the runtimes of various assemblies of the cooking appliance 1 are of interest, because the wear and the susceptibility of the individual assemblies may thus be acquired and analyzed centrally. It is thus possible for the producer to improve the quality of the cooking appliance in a targeted way. For the same reason, it is of special interest for the producer to be able to analyze error messages occurring during the operation of the cooking appliance 1.

It is expedient to provide the actual data with an associated time specification. The data are especially simple to analyze if they are stored directly in the memory of the server 10 in a format readable by a standard editor.

At a moment suitable for the user, for example, by actuating a button of an operating unit 13 of the cooking appliance 1, a triggering command is transmitted from the cooking appliance 1 to the server 10 through the connection for data transmission 7. The corresponding triggering command is stored with the current time in the memory 4. Subsequently, the server 10 authenticates itself with the cooking appliance 1. The user now has various options which are displayed on a display unit 16 of the cooking appliance, which may be implemented together with the operating unit 13. In particular, he may select the type of the data transmission via the operating unit 13. For example, data transmission alone or data transmission with analysis are available for selection. Such a selection may also be performed automatically by the cooking appliance 1, however.

Subsequently, the cooking appliance 1 establishes a secured connection to the server 10 via the connection for data transmission 7. The data transmission does not have to be performed via a cable and the associated routers, but rather may also be performed via a GPRS router using a wireless transmission. For this purpose, such a GPRS router (not shown) must be connected to the cooking appliance, which may replace the connection for data transmission 7.

A communication tunnel is established by encrypted data transmission, through which the server 10 receives access to the memory 4 of the cooking appliance 1. The server 10 then loads the data from the memory 4 onto a memory (not shown) in the server 10 via the connection for data transmission 7. By that various programs may be used on the server 10, with which correct and secure reading in the memory 4 of the cooking appliance 1 is possible. The data are subsequently processed and analyzed by further programs on the server 10. The data of interest to the producer are stored in a databank of the server 10. The data of interest to the user of the cooking appliance 1 are analyzed on the server 10 and stored by the server 10 in the memory 4 of the cooking appliance 1. Other data and programs than those described up to this point may also be stored by the server 10 in the memory 4 of the cooking appliance 1.

Subsequently, the connection between the server 10 and the cooking appliance 1 is interrupted. A processor (not shown) of the cooking appliance 1 now processes the data stored by the server 10 in the memory 4. The analyzed data may be displayed on the display 16 by the user and optionally selected and/or processed further with the aid of the user interface 13.

The cooking appliance 1 may transmit these data to a local computer (not shown), using which the data may then be stored and processed further, via the connection for data transmission 7. The possibility is provided that the local computer automatically orders supplies which are running short via the Internet with the aid of a program.

The local computer or the cooking appliance 1 itself may also be connected via the connection for data transmission 7 to a printer (not shown), which prints out specific data, for example, in the form of an order. The costs for power, gas, and water for the cooking appliance 1 may thus also be easily monitored and archived by the user.

Alternatively, the memory 4 may be disconnected from the cooking appliance 1 in order to be connected to a local computer (not shown) via a USB interface, for example, in order to analyze the data processed by the server 10 and stored in the memory 4.

The features of the invention disclosed in the preceding description, the claims, and the drawing may be essential for implementing the invention in its various embodiments both individually and also in any arbitrary combination.

### LIST OF REFERENCE NUMERALS

1 cooking appliance
4 memory
7 connection for data transmission
10 server
13 user interface
16 display

1. A method for communicating with a memory of a cooking appliance, the cooking appliance having at least one interface to a server, the method comprising:
storing data of the cooking appliance in the memory of the cooking appliance, and
after an authentication of the server in relation to the cooking appliance, reading, by the server, data stored in the memory of the cooking appliance via an encrypted data transmission, wherein the server performs an exchange of data with the cooking appliance without the cooking appliance requiring access to a memory of the server.

2. The method according to claim 1, wherein the server identifies itself to the cooking appliance using the authentication.

3. The method according to claim 1, further comprising establishing the encrypted data transmission in accordance with a corresponding configuration of the cooking appliance.

4. The method according to claim 3, wherein the configuration is determined by at least one of a manual request, a predefined asynchronous event, and a triggering command at regular time intervals or according to a timetable.

5. The method according to claim 4, wherein at least one of the manual request, the asynchronous event and the triggering command is recorded in the memory of the cooking appliance.

6. The method according to claim 4, wherein the server has access to the memory of the cooking appliance, depending on at least one of the manual request, the asynchronous event, and the triggering command.

7. The method according to claim 4, wherein depending on at least one of the manual request, the asynchronous event, and the triggering command, the server reads out data from the memory of the cooking appliance, analyzes the data, and stores the data in a databank.

8. The method according to claim 1, further comprising storing, by the server, data in the memory of the cooking appliance, wherein the cooking appliance processes data stored by the server in the memory, displays the data on a display unit of the cooking appliance, and/or prints out the data.

9. The method according to claim 1, wherein the data are selected from a set of data which is characteristic for hazard analysis and critical control points (HACCP) logs, at least one customer input, a type and/or number of at least one completed or aborted cleaning, decalcification, cooling, and/or cooking program, at least one error message, consumption data, and/or a runtime of at least one system component of the cooking appliance.

10. The method according to claim 1, further comprising storing associated time data with the data of the cooking appliance.

11. (canceled)

12. The method according to claim 1, wherein the encrypted data transmission is performed via a network connection between the cooking appliance and the server.

13. The method according to claim 1, further comprising disconnecting the memory of the cooking appliance from the cooking appliance and connecting the memory to a computing unit for transmission of data in the memory.

14. (canceled)

15. A cooking appliance, comprising at least one memory for storing data of the cooking appliance, a user interface, and at least one interface to at least one server for transmitting data between the memory and the server,
wherein, after an authentication of the server in relation to the cooking appliance, the data are transmitted between the memory of the cooking appliance and the server via an encrypted data transmission without the cooking appliance requiring access to a memory of the server.

16-18. (canceled)

19. The cooking appliance according to claim 15, wherein the encrypted data transmission is established in accordance with a corresponding configuration of the cooking appliance.

20. The cooking appliance according to claim 19, wherein the configuration is determined by at least one of a manual request, a predefined asynchronous event, and a triggering command at time intervals or according to a timetable.

21. The cooking appliance according to claim 20, wherein depending on at least one of the manual request, the asynchronous event, and the triggering command, the server is configured to read data from the memory of the cooking appliance, analyze the data, and store the data in a databank.

22. The cooking appliance according to claim 15, wherein the cooking appliance is further configured to store data received from the server in the memory of the cooking appliance.

23. The method according to claim 7, further comprising storing, by the server, data from the databank in the memory of the cooking appliance.

24. The method according to claim 1, further comprising storing, with the data of the cooking appliance, data on the setup location of the cooking appliance comprising geographic location and/or geodetic altitude.

25. The method according to claim 1, wherein the encrypted data transmission is performed directly if the memory of the cooking appliance is disconnected from the cooking appliance and connected to the server.

26. A method for communicating data between a cooking appliance and a server, the method comprising:
receiving a communication request from the cooking appliance;
in response to the communication request:
authenticating the server to the cooking appliance;
establishing an encrypted data transmission connection with the cooking appliance;
receiving data stored in a memory of the cooking appliance via the encrypted data transmission connection; and
storing the data in a memory of the server,
wherein the data are communicated between the cooking appliance and the server without the cooking appliance having access to the memory of the server.

27. The method according to claim 26, wherein the communication request is initiated by at least one of a manual request, a predefined asynchronous event, and a triggering command.
